(19) United States
(12) Patent Application Publication
(10) Pub. No.: US 2017/0127331 A1
(43) Pub. Date: May 4, 2017

(54) Device and Method of Handling Communication Failure

(71) Applicant: HTC Corporation, Taoyuan City (TW)

(72) Inventor: Chih-Hsiang Wu, Taoyuan City (TW)

(21) Appl. No.: 15/335,465

(22) Filed: Oct. 27, 2016

Related U.S. Application Data
(60) Provisional application No. 62/247,733, filed on Oct. 28, 2015.
(60) Provisional application No. 62/286,430, filed on Jan. 24, 2016.

(51) Int. Cl. H04W 36/30; H04W 76/04; H04W 28/02

(52) U.S. Cl. CPC H04W 36/30; H04W 28/0268; H04W 76/046

(57) ABSTRACT

A communication device for handling a handover failure comprises a storage unit for storing instructions and a processing circuit coupled to the storage unit. The processing circuit is configured to execute the instructions stored in the storage unit. The instructions comprise transmitting at least one packet of a communication call via a first bearer to a first base station (BS); receiving a handover command from the first BS, wherein the handover command hands over the first bearer to a second BS; performing a handover from the first BS to the second BS; determining that a handover failure of the handover occurs; and transmitting a first message to a third BS, wherein the first message comprises first information which indicates the handover failure and presence of the first bearer.

### CROSS REFERENCE TO RELATED APPLICATIONS

This application claims the benefit of U.S. Provisional Application No. 62/247,733 filed on Oct. 28, 2015, and the benefit of U.S. Provisional Application No. 62/286,430 filed on Jan. 24, 2016, which are incorporated herein by reference.

### BACKGROUND OF THE INVENTION

1. Field of the Invention

The present invention relates to a device and a method used in a wireless communication system, and more particularly, to a device and a method of handling a communication failure.

2. Description of the Prior Art

A long-term evolution (LTE) system provides high data rate, low latency, packet optimization, and improved system capacity and coverage. The LTE system continues to be evolved to increase peak data rate and throughput by using advanced techniques, such as carrier aggregation (CA), dual connectivity (DC), licensed-assisted access, etc.

A communication call performed by a UE via a service class identifier (QCI) 1 bearer may be dropped due to a handover failure. According to the prior art, a network server is not able to collect information of a communication call drop caused by the handover failure from the UE, because the UE does not include presence of the QCI 1 bearer upon the handover failure in a radio link failure (RLF) report. Thus, the network server is not able to perform correct operations in response to the communication call drop. Thus, how to handle the handover failure is an important problem to be solved.

A network operator may intend to collect a call drop of a call performed via a quality of service class indicator (QCI) 1 bearer over a secondary cell group (SCG) in the UE when the UE is configured to simultaneously connect to a master eNB (MeNB) and a secondary eNB (SeNB), e.g., according to dual connectivity defined in 3GPP specifications. However, it is unknown how the network operator can collect information of the call drop caused by a SCG change failure, because related operations are not defined in the 3GPP specifications. Thus, how to handle the SCG change failure is an important problem to be solved.

### SUMMARY OF THE INVENTION

The present invention therefore provides a communication device and method for handling a communication failure.

A communication device for handling a handover failure comprises a storage unit for storing instructions and a processing circuit coupled to the storage unit. The processing circuit is configured to execute the instructions stored in the storage unit. The instructions comprise transmitting at least one packet of a communication call via a first bearer to a first base station (BS); receiving a handover command from the first BS, wherein the handover command hands over the first bearer to a second BS; performing a handover from the first BS to the second BS; determining that a handover failure of the handover occurs; and transmitting a first message to a third BS, wherein the first message comprises first information which indicates the handover failure and presence of the first bearer.

A network server for handling a handover failure comprises a storage unit for storing instructions and a processing circuit coupled to the storage unit. The processing circuit is configured to execute the instructions stored in the storage unit. The instructions comprise receiving at least one first information from a first base station (BS), wherein the at least one first information indicates at least one first call drop caused by a handover failure (HOF) or a radio link failure (RLF); receiving at least one second information from a second BS, wherein the at least one second information indicates at least one second call drop caused by the HOF or the RLF; and generating a call drop analysis report which indicates the number of call drops caused by the HOF and/or the number of call drops caused by the RLF according to the at least one first information and the at least one second information.

A communication device for handling a communication failure comprises a storage unit for storing instructions and a processing circuit coupled to the storage unit. The processing circuit is configured to execute the instructions stored in the storage unit. The instructions comprise receiving a first configuration configuring a first radio bearer (RB) as a master cell group (MCG) bearer for communicating with a first base station (BS) from the first BS; receiving at least one second configuration configuring at least one second RB as a secondary cell group (SCG) or a split bearer for communicating with a second BS from the first BS; detecting a communication failure when communicating with the first BS; generating a failure report indicating the communication failure; determining whether to allocate information indicating at least one specific type service dropped in the failure report in response to the communication failure; allocating the information in the failure report, if one of the at least one second RB is used for the at least one specific type service; and transmitting a failure information message comprising the failure report to the first BS in response to the communication failure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is a flowchart of a process according to an example of the present invention.

FIG. 5 is a flowchart of a process according to an example of the present invention.

FIG. 6 is a flowchart of a process according to an example of the present invention.

FIG. 7 is a flowchart of a process according to an example of the present invention.

### DETAILED DESCRIPTION

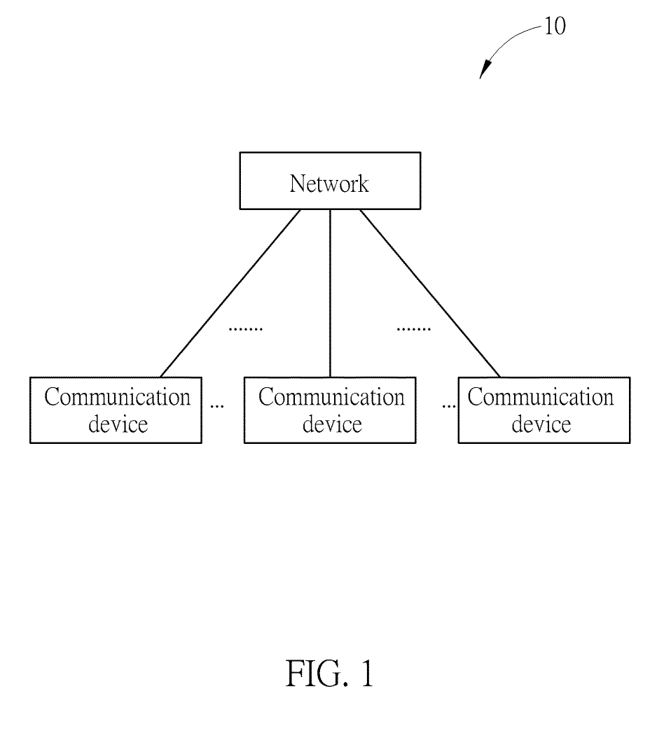

FIG. 1 is a schematic diagram of a wireless communication system 10 according to an example of the present invention. The wireless communication system 10 briefly consists of a network and a plurality of communication devices. The network and a communication device communicate with each other via one or more carriers of licensed band(s) and/or unlicensed band(s). The network and the communication device may simultaneously communicate with each other via multiple cells (e.g., multiple carriers) including a primary cell (PCell) and one or more secondary cells (SCells). The abovementioned cells may be operated in the same or different frame structure types, or in the same or different duplexing modes, i.e. frequency-division duplexing (FDD) and time-division duplexing (TDD). For example, the PCell may be operated on a licensed carrier, while the SCell may be operated on an unlicensed carrier.

In FIG. 1, the network and the communication devices are simply utilized for illustrating the structure of the wireless communication system 10. Practically, the network may be a narrowband (NB) internet of things (IoT) network or an evolved universal terrestrial radio access network (E-UTRAN) including at least one evolved Node-B (eNB). The network may be a fifth generation (5G) network including at least one 5G base station (BS) which employs orthogonal frequency-division multiplexing (OFDM) and/or non-OFDM and a transmission time interval (TTI) shorter than 1 ms (e.g. 100 or 200 microseconds), to communicate with the communication devices. In general, a BS may also be used to refer any of the eNB and the 5G BS (or called gNB). In addition, the network may further include a network server for processing information received from the communication devices via the at least one eNB or gNB.

A communication device may be a user equipment (UE), an internet of things (IoT) device, a mobile phone, a laptop, a tablet computer, an electronic book, a portable computer system, a vehicle, an aircraft. In addition, the network and the communication device can be seen as a transmitter or a receiver according to direction (i.e., transmission direction), e.g., for an uplink (UL), the communication device is the transmitter and the network is the receiver, and for a downlink (DL), the network is the transmitter and the communication device is the receiver.

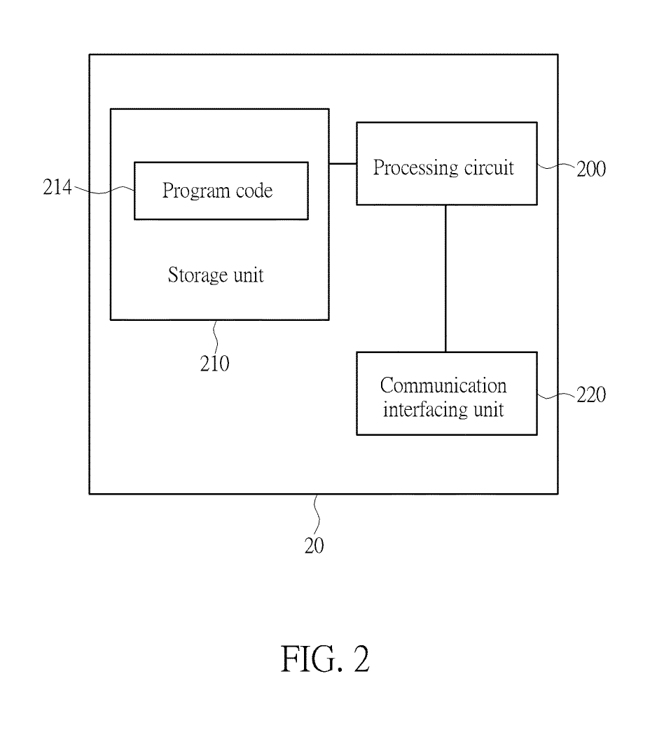

FIG. 2 is a schematic diagram of a communication device 20 according to an example of the present invention. The communication device 20 may be a communication device or the network shown in FIG. 1, but is not limited herein. The communication device 20 may include a processing circuit 200 such as a microprocessor or Application Specific Integrated Circuit (ASIC), a storage unit 210 and a communication interfacing unit 220. The storage unit 210 may be any data storage device that may store a program code 214, accessed and executed by the processing circuit 200. Examples of the storage unit 210 include but are not limited to a subscriber identity module (SIM), read-only memory (ROM), flash memory, random-access memory (RAM), hard disk, optical data storage device, non-volatile storage unit, non-transitory computer-readable medium (e.g., tangible media), etc. The communication interfacing unit 220 is preferably a transceiver and is used to transmit and receive signals (e.g., data, messages and/or packets) according to processing results of the processing circuit 200.

In the following embodiments, a UE is used to represent a communication device in FIG. 1, to simplify the illustration of the embodiments.

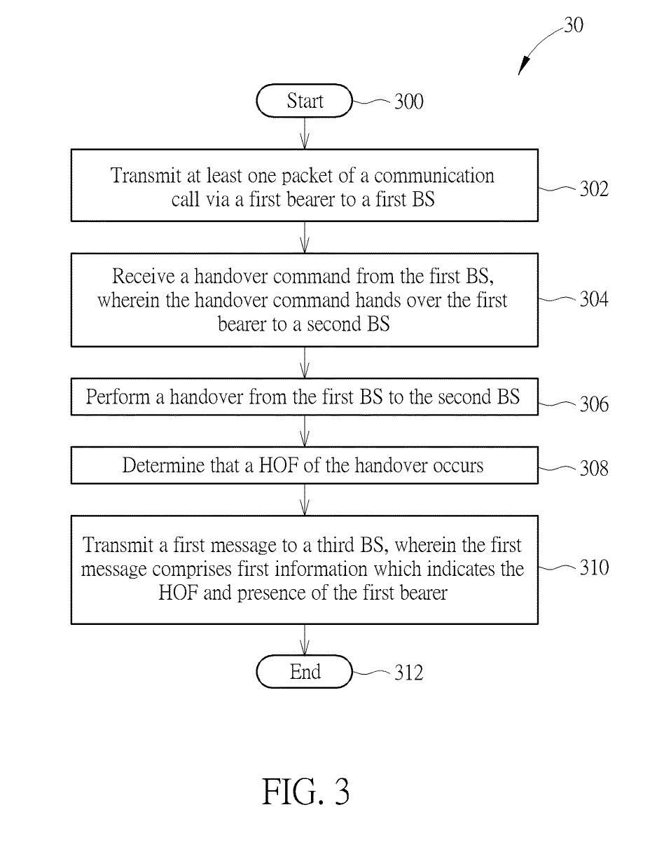

FIG. 3 is a flowchart of a process 30 according to an example of the present invention. The process 30 may be utilized in a UE, for handling a handover failure (HOF). The process 30 may be compiled into the program code 214 and includes the following steps:

Step 300: Start.

Step 302: Transmit at least one packet of a communication call via a first bearer to a first BS.

Step 304: Receive a handover command from the first BS, wherein the handover command hands over the first bearer to a second BS.

Step 306: Perform a handover from the first BS to the second BS.

Step 308: Determine that a HOF of the handover occurs.

Step 310: Transmit a first message to a third BS, wherein the first message comprises first information which indicates the HOF and presence of the first bearer.

Step 308: End.

According to the process 30, the UE transmits at least one packet of a communication call via a first bearer to a first BS. The UE receives a handover command from the first BS, wherein the handover command hands over the first bearer to a second BS. The UE performs a handover from the first BS to the second BS. The communication call may be a voice call or a video call. Then, the UE determines (e.g., detect) that a HOF of the handover occurs. The UE transmits a first message to a third BS, wherein the first message comprises first information which indicates the HOF and presence of the first bearer. That is, the presence of the first bearer for performing the communication call is indicated to the third BS. Thus, the third BS or a network server which receives the first information from the third BS is able to perform correct operations in response to the HOF. The third BS may be the first BS, the second BS or another BS, and is not limited herein.

Realization of the process 30 is not limited to the above description. The following examples may be applied to the process 30.

In one example, the UE transmits the first message to the third BS, when the UE receives a first request message requesting the UE to transmit the first message, from the third BS. In one example, the first information may be a first radio link failure (RLF) report which includes a connection failure type set to “hof” and an indication of the first bearer (e.g., by using a Boolean type field or an enumeration type field). When the network (e.g., the network server) receives the RLF report from the third BS, the network knows that a call drop happens due to a HOF. In one example, the first bearer may be a quality of service class identifier (QCI) 1 bearer or a QCI 2 bearer. In one example, the handover command is an RRCConnectionReconfiguration message.

In one example, the first BS is an eNB, the second BS is a universal mobile telecommunication system (UMTS) BS or a global system for mobile communications (GSM) BS, and the handover command may be a MobilityFromEUTRACommand which indicates the UE to perform a single radio voice call continuity (SRVCC) handover. The first information further indicates that the handover is an inter-radio access technology (RAT) handover. In one example, the first information may be a first RLF report which includes a connection failure type set to “hof”, an indication of the first bearer (e.g., by using a Boolean type field or an enumeration type field) and an indication of the inter-RAT handover. Hence, when the network receives the RLF report from the third BS, the network knows that a call drop happens due to a SRVCC HOF. If the indication of the inter-RAT handover is not included in the RLF report, the network knows that a call drop happens due to an intra-RAT (e.g., LTE) HOF. In addition, if the indication of the inter-RAT handover is not defined (e.g., in the 3rd Generation Partnership Project (3GPP) specifications), the UE only reports the intra-RAT HOF and the network can only receive call drop information caused by the intra-RAT handover from the UE.

In one example, When the UE is configured with a QCI 1 bearer for transmitting and/or receiving packet(s) of the communication call and detects the RLF, the UE stores information which indicates the RLF and the presence of the QCI 1 bearer. After the RLF, the UE may connect to a fourth BS to transmit a second message which includes the information to the fourth BS. The fourth BS may be the first BS, the second BS, the third BS or another BS, and is not limited herein.

The first and second messages are the same message or different messages. In one example, the first and second messages are UEInformationResponse messages. The UE transmits a UEInformationResponse message in response to receiving a UEInformationRequest message from the fourth BS.

According to the above description, an example is illustrated as follows. The first bearer is an evolved packet system (EPS) bearer with QCI 1 setting (i.e., QCI 1 bearer) configured by the network. The first BS configures a data radio bearer (RB) corresponding to the EPS bearer to the UE. The UE transmits and/or receives packet(s) of the communication call via the EPS bearer. When the UE does not successfully perform the handover to the second BS within a time interval, the UE determines that the HOF occurs and stores the first information which indicates the HOF and the presence of the QCI 1 bearer. After the HOF, the UE may connect to the third BS, to transmit the first message including the first information to the third BS.

According to the above description, an example is illustrated as follows. The first bearer is an EPS bearer with QCI 1 setting (i.e., QCI 1 bearer) configured by the network. The first BS configures a data RB corresponding to the EPS bearer to the UE. The UE transmits and/or receives packet (s) of the communication call via the EPS bearer. When the UE does not successfully perform the SRVCC handover to the second BS (e.g., GSM BS or UMTS BS) within a time interval, the UE determines that a SRVCC HOF and stores information which indicates the SRVCC HOF. After the SRVCC HOF, the UE may connect to the third BS, to transmit the first message including the information to the third BS.

According to the above description, the first information may further indicate a call type of the communication call. For example, the call type is set to voice when the communication call is a voice call, and the call type is set to video when the communication call is a video call. When the UE has a voice call and a video call, a call type may be set to both. In another example, the call type may be set to voice, if a voice call drop is more important than a video call drop, e.g., from a network operator's perspective. The call type may be set to video, if the video call drop is more important than the voice call drop from the network operator's perspective.

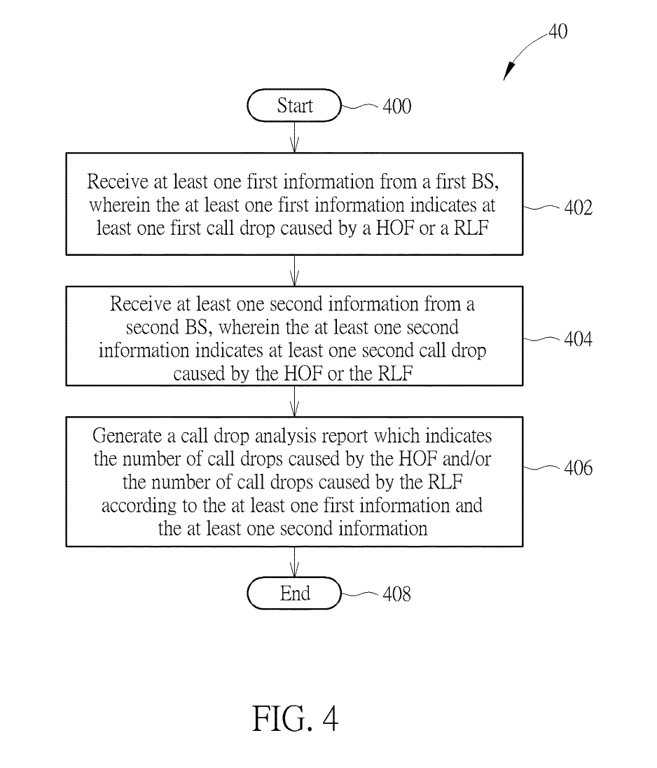

FIG. 4 is a flowchart of a process 40 according to an example of the present invention. The process 40 is utilized in a network server in the network, for handling a HOF. The process 40 may be compiled into the program code 214 and includes the following steps:

Step 400: Start.

Step 402: Receive at least one first information from a first BS, wherein the at least one first information indicates at least one first call drop caused by a HOF or a RLF.

Step 404: Receive at least one second information from a second BS, wherein the at least one second information indicates at least one second call drop caused by the HOF or the RLF.

Step 406: Generate a call drop analysis report which indicates the number of call drops caused by the HOF and/or the number of call drops caused by the RLF according to the at least one first information and the at least one second information.

Step 408: End.

According to the process 40, the network server receives at least one first information from a first BS, wherein the at least one first information indicates at least one first call drop caused by a HOF or a RLF. The network server also receives at least one second information from a second BS, wherein the at least one second information indicates at least one second call drop caused by the HOF or the RLF. Then, the network server generates a call drop analysis report which indicates the number of call drops caused by the HOF and/or the number of call drops caused by the RLF according to the at least one first information and the at least one second information. That is, the network server collects information associated with various types related to operation failures described above, to generate the call drop analysis report.

The first information and the second information may further include location information indicating a location where the HOF or the RLF occurs. An operator of the network server may use the call drop analysis report to improve coverage of the location. The call drop analysis report may further be associated to at least one UE made by a UE vendor. Thus, the operator may deliver the call drop analysis report to a UE vendor. The UE vendor improves the at least one UE according to the call drop analysis report.

The first BS may receive the at least one first information from at least one first UE as described in the process 30. The second BS may receive the at least one second information from at least one second UE as described in the process 30. The at least one first and the at least one second UE may be a same UE or may be different UEs. The examples of the process 30 may be applied to the process 40, and is not narrated herein. For example, the description of the first information in the process 30 may be applied to the first information and the second information in the process 40.

Realization of the process 40 is not limited to the above description. The following examples may be applied to the process 40.

In one example, the number of the call drops caused by the HOF includes at least one of: the number of voice call drops caused by the HOF and the number of video call drops caused by the HOF. The number of the call drops caused by the RLF includes at least one of: the number of voice call drops caused by the RLF and the number of video call drops caused by the RLF.

In one example, the number of call drops caused by the HOF includes at least one of: the number of voice call drops caused by an intra-RAT HOF, the number of voice call drops caused by a SRVCC HOF, the number of video call drops caused by an intra-RAT HOF and the number of video call drops caused by a SRVCC HOF.

In one example, the network server generates the call drop analysis report for a same UE, for UEs of the same model or for UEs of the same brand according to the first information and second information. The network server identifies the same UE, the UEs of the same model or the UEs of the same brand according to international mobile equipment identit(ies) (IMEI(s)) of the UE(s).

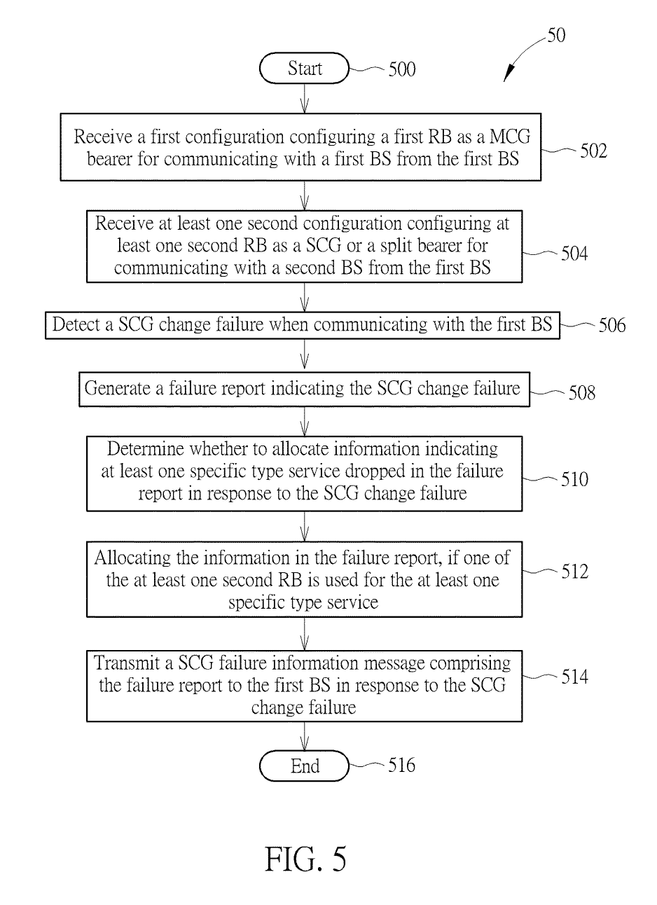

FIG. 5 is a flowchart of a process 50 according to an example of the present invention. The process 50 may be utilized in a UE, for handling a communication failure with multiple BSs. The process 50 maybe compiled into the program code 214 and includes the following steps:

Step 500: Start.

Step 502: Receive a first configuration configuring a first RB as a master cell group (MCG) bearer for communicating with a first BS from the first BS.

Step 504: Receive at least one second configuration configuring at least one second RB as a secondary cell group (SCG) or a split bearer for communicating with a second BS from the first BS.

Step 506: Detect a SCG change failure when communicating with the first BS.

Step 508: Generate a failure report indicating the SCG change failure.

Step 510: Determine whether to allocate information indicating at least one specific type service dropped in the failure report in response to the SCG change failure.

Step 512: Allocating the information in the failure report, if one of the at least one second RB is used for the at least one specific type service.

Step 514: Transmit a SCG failure information message comprising the failure report to the first BS in response to the SCG change failure.

Step 516: End.

According to the process 50, the UE receives a first configuration configuring a first RB as a MCG bearer for communicating with a first BS (e.g., master eNB (MeNB)) from the first BS. The UE receives at least one second configuration configuring at least one second RB as a SCG bearer or a split bearer for communicating with the second BS (e.g., SeNB (SeNB)) from the first BS, e.g., via the first RB or another RB which is a MCG bearer. The UE detects a SCG change failure when communicating with the first BS, and generates a failure report in response to the SCG change failure. Accordingly, the UE determines whether to allocate information indicating at least one specific type service dropped in the failure report in response to the SCG change failure. If one of the at least one second RB is used for the at least one specific type service (e.g., data of the at least one specific type service is transmitted via the second RB), the UE determines to allocate the information in the failure report. If none of the at least one second RB is associated with the at least one specific type service or none of the at least one specific type service is performed by the UE, the UE does not allocate the information in the failure report. Accordingly, the UE transmits a SCG failure information message comprising the failure report to the first BS in response to the SCG change failure. Thus, the first BS can collect information of the at least one specific type service dropped due to the SCG change failure. As a result, the network can improve performance of communications with the UE according to the failure report.

Realization of the process 50 is not limited to the above description. The following examples may be applied to the process 50.

In one example, the at least one specific type service includes a voice call service, a streaming service and/or a video call service. Packet(s) of the voice call service, the streaming service or the video call service maybe transmitted via an EPS bearer with a specific QCI setting (e.g., QCI 1 bearer or QCI 2 bearer). The specific QCI setting may be defined in 3GPP specifications (e.g., 3GPP TS 23.203) for each of the at least one specific type service. The network configures the EPS bearer and one of the at least one second RB associated to the EPS bearer to the UE. When the UE detects the SCG change failure, the UE stores information which indicates the at least one specific service dropped or the QCI 1 bearer dropped. The UE transmits the SCG failure information message which includes a first failure report which includes the information and indicates the SCG change failure, to the first BS. When the first BS receives the first failure report, the first BS transmits the first failure report to a network server (e.g., for operation and/or maintenance). The network server may receive a second failure report from the UE via the first BS or the second BS. The second failure report indicates the SCG change failure, and is transmitted by the UE in another SCG failure information message. The second failure report may not include information which indicates the at least one specific service dropped or the QCI 1 bearer dropped, because none of the at least one specific service is running when the UE detects the SCG change failure. For example, the UE only has an internet data service on all of the at least one second RB. The network server may receive a first plurality of failure reports (similar to the first failure report) and a second plurality of failure reports (similar to the second failure report), such the network server can generate a call drop analysis report for the UE according to the first plurality of failure reports and the second plurality of failure reports. In one example, the call drop analysis report may provide the number of drops for the at least one specific service and the number of drops for other services (i.e., not belonging to the at least one specific service). If the UE indicates each of the at least one specific service in the first failure report, the network server is able to provide the number of drops for each, some or all of the at least one specific service.

The UE may transmit a third failure report in another message (e.g., SCG failure information message or UEInformationResponse message) to a BS (e.g., the first BS, the second BS or another BS). The network server may receive the third failure report from the BS. The third failure report includes information which indicates a RLF and at least one specific service dropped due to the RLF. The network server receives a plurality of failure reports (similar to the third failure report) from the UE. Thus, the network server can generate a call drop analysis report for the UE according to the first plurality of reports and the third plurality of failure reports. In one example, the call drop analysis report provides the number of drops for the at least one specific service. In one example, the call drop analysis report provides the number of drops for each of the at least one specific service. In another example, the call drop analysis report provides the number of drops caused by the SCG change failure and the number of drops caused by the RLF.

In one example, a plurality of UEs may transmit the first failure report, the second failure report and/or the third failure report to a BS as described above. The BS transmits the first failure report, the second failure report and/or the third failure report to the network server. The network server may generate a call drop analysis report which provides the number of drops for each, some or all of the at least one specific service for the plurality of UEs, when the plurality of UEs use the same modem chip/chipset or different modem chips/chipsets from a same chip manufacturer or are manufactured by a same device manufacturer. Thus, a network operator may request the chip manufacturer or the device manufacturer to improve performance or quality of the plurality of UEs according to the other call drop analysis report.

It should be noted that a call drop analysis report described above may explicitly indicate a drop cause (e.g., SCG change failure, HOF or RLF) and the specific service for each of drops, such that the number of drops for each drop cause can be obtained. The RLF may further be divided into sub causes such as timer expiry (e.g., T310 expiry or T312 expiry), random access problem in a MCG access or a SCG access and that the maximum number of retransmissions has been reached in a MCG radio link control (RLC) layer or a SCG RLC layer. The HOF may be an intra-RAT handover (e.g., intra-LTE handover) failure or an inter-RAT handover (e.g., SRVCC handover or packet-switched (PS) handover) failure. The failure report may be a RLF-report and the drop cause may be a failure type.

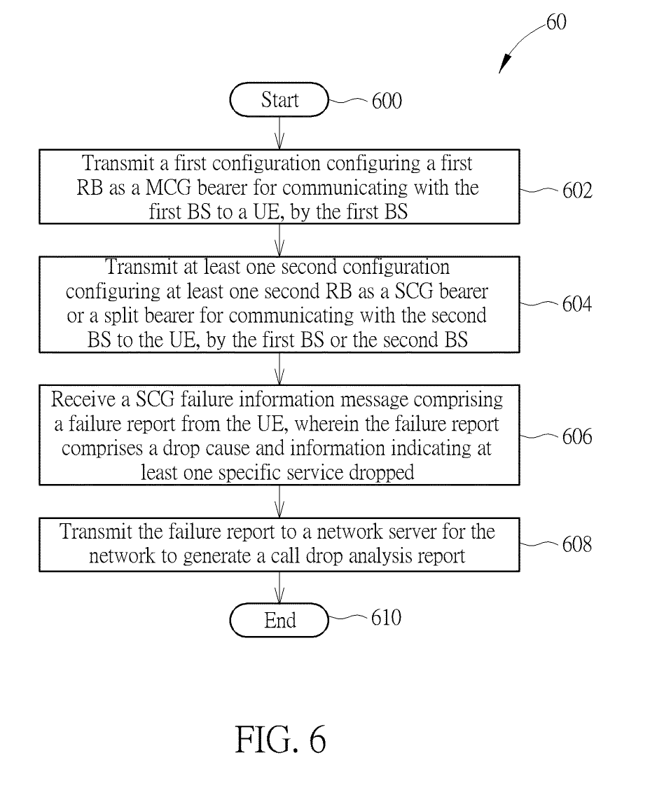

FIG. 6 is a flowchart of a process 60 according to an example of the present invention. The process 60 may be utilized in BSs, for handling a communication failure with a UE. The process 60 may be compiled into the program code 214 and includes the following steps:

Step 600: Start.

Step 602: Transmit a first configuration configuring a first RB as a MCG bearer for communicating with the first BS to a UE, by the first BS.

Step 604: Transmit at least one second configuration configuring at least one second RB as a SCG bearer or a split bearer for communicating with the second BS to the UE, by the first BS or the second BS.

Step 606: Receive a SCG failure information message comprising a failure report from the UE, wherein the failure report comprises a drop cause and information indicating at least one specific service dropped.

Step 608: Transmit the failure report to a network server for the network to generate a call drop analysis report.

Step 610: End.

According to the process 60, the first BS (e.g., MeNB) may transmit a first configuration configuring a first RB as a MCG bearer for communicating with the first BS to a UE. The first BS or the second BS (e.g., SeNB) may transmit a second configuration configuring at least one second RB as a SCG bearer or a split bearer for communicating with the second BS to the UE. After a while, the first BS may receive a SCG change failure information message comprising a failure report from the UE, wherein the failure report comprises a drop cause (e.g., SCG change failure, HOF or RLF) and information indicating at least one specific service dropped, because the UE detects a RLF or a SCG change failure when performing the at least one specific service as described previously. The examples related to the process 50 may be applied to the process 60, and are not narrated herein.

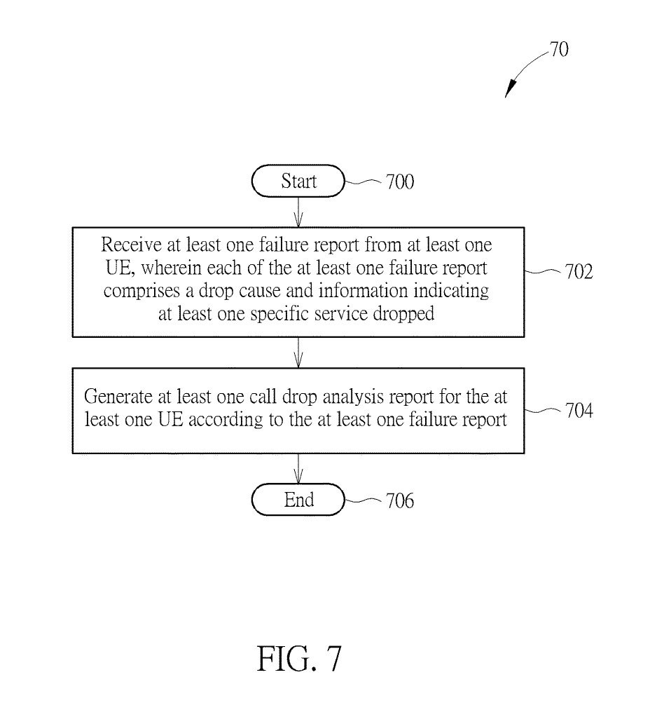

FIG. 7 is a flowchart of a process 70 according to an example of the present invention. The process 70 may be utilized in a network server, for generating at least one call drop analysis report for one or multiple UEs. The process 70 may be compiled into the program code 214 and includes the following steps:

Step 700: Start.

Step 702: Receive at least one failure report from at least one UE, wherein each of the at least one failure report comprises a drop cause and information indicating at least one specific service dropped.

Step 704: Generate at least one call drop analysis report for the at least one UE according to the at least one failure report.

Step 706: End.

According to the process 70, the network server receives at least one failure report from at least one UE, wherein each of the at least one failure report includes a drop cause and information indicating at least one specific service dropped. The network server generates at least one call drop analysis report for the at least one UE according to the at least one failure report.

Realization of the process 70 is not limited to the above description. The following examples are applied to the process 70.

In one example, each of the at least one failure report may be transmitted in a SCG failure information message or a UE Information Response message. In one example, each of the at least one failure report may include a drop cause and may or may not include information indicating the at least one specific service dropped. In one example, the at least one call drop analysis report indicates the number of the at least one specific service dropped due to a drop cause. The examples related to the process 50 may be applied to the process 70, and are not narrated herein.

Those skilled in the art should readily make combinations, modifications and/or alterations on the abovementioned description and examples. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the communication device 20. Any of the processes above may be compiled into the program code 214.

To sum up, the present invention provides a device and a method for handling a communication failure. A network (e.g., a BS or a network server) receiving information indicating a HOF and presence of a specific bearer is able to perform correct operations in response to the HOF. In addition, the network is able to collect information associated with various types related to operation failures, to generate a call drop analysis report. Thus, the network can improve performance of communications with a UE according to the call drop analysis report.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device for handling a handover failure, comprising:
a storage unit, for storing instructions of:
transmitting at least one packet of a communication call via a first bearer to a first base station (BS);
receiving a handover command from the first BS, wherein the handover command hands over the first bearer to a second BS;
performing a handover from the first BS to the second BS;
determining that a handover failure of the handover occurs; and
transmitting a first message to a third BS, wherein the first message comprises first information which indicates the handover failure and presence of the first bearer; and
a processing circuit, coupled to the storage unit, configured to execute the instructions stored in the storage unit [1, 2, 3].

2. The communication device of claim 1, wherein the communication device transmits the first message to the third BS, when the communication device receives a first request message requesting the communication device to transmit the first message, from the third BS.

3. The communication device of claim 1, wherein the first bearer is a quality of service class identifier (QCI) 1 bearer.

4. The communication device of claim 1, wherein the first BS and the second BS are long-term evolution (LTE) base stations, and the handover command is an RRCConnectionReconfiguration message.

5. The communication device of claim 1, wherein the first BS is a LTE base station, the second BS is a universal mobile telecommunication system (UMTS) BS or a global system for mobile communications (GSM) BS, and the handover command is a MobilityFromEUTRACommand which indicates the communication device to perform a single radio voice call continuity (SRVCC) handover.

6. The communication device of claim 5, wherein the first information further indicates that the handover is an inter-radio access technology (RAT) handover.

7. The communication device of claim 1, wherein the storage unit further stores instructions of:
determining that a radio link failure (RLF) occurs;
transmitting a second message to a fourth BS, wherein the second message comprises second information which indicates that the RLF occurs and the presence of the first bearer.

8. The communication device of claim 1, wherein the handover command is a single radio voice call continuity (SRVCC) command, the handover is a SRVCC handover, and the handover failure is a SRVCC handover failure [2].

9. A network server for handling a handover failure, comprising:
a storage unit, for storing instructions of:
receiving at least one first information from a first base station (BS), wherein the at least one first information indicates at least one first call drop caused by a handover failure (HOF) or a radio link failure (RLF);
receiving at least one second information from a second BS, wherein the at least one second information indicates at least one second call drop caused by the HOF or the RLF; and
generating a call drop analysis report which indicates the number of call drops caused by the HOF and/or the number of call drops caused by the RLF according to the at least one first information and the at least one second information; and
a processing circuit, coupled to the storage unit, configured to execute the instructions stored in the storage unit [4].

10. The network server of claim 9, wherein the number of call drops caused by the HOF comprises at least one of the number of voice call drops caused by the HOF and the number of video call drops caused by the HOF, and the number of call drops caused by the RLF includes at least one of the number of voice call drops caused by the RLF and the number of video call drops caused by the RLF.

11. The network server of claim 9, wherein the number of call drops caused by the HOF comprises at least one of:
the number of voice call drops caused by an intra-radio access technology (RAT) HOF, the number of voice call drops caused by a single radio voice call continuity (SRVCC) HOF, the number of video call drops caused by an intra-RAT HOF, and the number of video call drops caused by a SRVCC HOF.

12. A communication device for handling a communication failure, comprising:
a storage unit, for storing instructions of:
receiving a first configuration configuring a first radio bearer (RB) as a master cell group (MCG) bearer for communicating with a first base station (BS) from the first BS;
receiving at least one second configuration configuring at least one second RB as a secondary cell group (SCG) or a split bearer for communicating with a second BS from the first BS;
detecting a communication failure when communicating with the first BS;
generating a failure report indicating the communication failure;
determining whether to allocate information indicating at least one specific type service dropped in the failure report in response to the communication failure;
allocating the information in the failure report, if one of the at least one second RB is used for the at least one specific type service; and
transmitting a failure information message comprising the failure report to the first BS in response to the communication failure; and
a processing circuit, coupled to the storage unit, configured to execute the instructions stored in the storage unit [process 30].

13. The communication device of claim 12, wherein the at least one specific type service comprises a voice call service, a streaming service and/or a video call service.

14. The communication device of claim 13, wherein at least one packet of the voice call service, the streaming service or the video call service is transmitted via a quality of service class identifier (QCI) 1 bearer.

15. The communication device of claim 12, wherein the communication failure is a SCG change failure or a radio link failure (RLF).
